(19) United States
(12) Patent Application Publication
(10) Pub. No.: US 2007/0292587 A1
(43) Pub. Date: Dec. 20, 2007

(54) Deep-frozen finished product of the type soup, puree or sauce and method for the manufacture of such a deep-frozen finished product

(76) Inventor: Maarten Maddens, Ooigem (BE)

Correspondence Address: James C. Wray;Suite 300, 1493 Chain Bridge Road, McLean, VA, 22101, US

(21) Appl. No.: 11/454,146

(22) Filed: Jun. 16, 2006

(51) Int. Cl. A23L 1/40

(52) U.S. Cl. 426/589

(57) ABSTRACT

The invention relates firstly to a deep-frozen finished product of the type soup, purée or sauce, wherein the ingredients of the deep-frozen finished product comprise deep-frozen ingredients, wherein at least some of the deep-frozen ingredients are cold processed to a cold emulsion. Secondly the invention relates to a method for the manufacture of a deep-frozen finished product of the type soup, purée or sauce, wherein the ingredients of the deep-frozen finished product include deep-frozen ingredients, and wherein at least some of the deep-frozen ingredients are cold processed to a cold emulsion.

The invention relates firstly to a deep-frozen finished product of the type soup, purée or sauce, where the ingredients of the deep-frozen finished product include deep-frozen ingredients, and secondly to a method for the manufacture of such a deep-frozen finished product.

A deep-frozen finished product means a product, consisting of a package and a food, which is stored in a deep-freeze, with the consumer being able with a limited number of actions to process the food to a food ready for consumption.

It is known to produce deep-frozen soups, soups in Tetrabrik, (ultra)fresh soups, etc. by a method in which the ingredients, amongst others vegetables, are cooked by the producer.

The disadvantage of this method, however, is that the ingredients of the soup are cooked a second time when they are made ready by the consumer. This results in a loss of color, texture, odor, flavor and vitamin content of the ingredients.

US 2003/0185944 describes a kit for the preparation of a meal comprising individually deep-frozen (IQF or “Individually quick frozen”) prepared meat or an IQF vegetable, or both, and a dry flavor-enhancing powder, where the IQF prepared meat or the IQF vegetable, or both, are not cooked in a liquid before they are packaged. The kit is furthermore almost free of liquid or frozen liquid. The vegetables used are first blanched with boiling water so that the enzymes are deactivated. After blanching the vegetables are treated with an IQF deep-freezer in order to produce deep-frozen food of high quality. In one of the examples a soup is described in which dry flavor-enhancing powders are vacuum-packed together with IQF vegetables and IQF potatoes.

The disadvantage of such kits is that water has to be added in order to make the meal ready.

GB 2 025 197 describes a method for the preparation of deep-frozen meals of the hotpot or casserole type, and such a meal. The meal mix consists of deep-frozen vegetables which are previously blanched, and are precooked to a greater or les ser degree together with the other ingredients, such as potatoes, peas, lentils and other vegetables. In addition, dry thickening agents, which already include flavor- and aroma-enhancing components, are added to this mix. Fats can also be added to this dry thickening agents mix. The dry ingredients of the mix, such as potato peelings, pea powder and other starch, are mixed with one part of water in order to obtain separate granules. These granules are mixed with precooked potatoes, or depending on taste with rice or pasta and with the deep-frozen vegetables, with the proportion of dry matter relative to the vegetables being between 15 and 25% dry mix. In one of the recipes for making a water-based French beans meal it is specified that the mixing process is completed when the ingredients are uniformly distributed among each other and the binding agent used in this recipe adheres to the vegetables.

Here too the disadvantage is that water has to be added in order to prepare the meal.

The object of the invention is thus on the one hand to provide a deep-frozen finished product of the type soup, purée or sauce, where in the consumer can make the deep-frozen finished product ready for consumption (consumable) in a simple manner, without adding additional ingredients, and furthermore to provide a deep-frozen finished product which only once has to undergo a cooking heat treatment in order to make the deep-frozen finished product ready for consumption.

This object of the invention is achieved by providing a deep-frozen finished product of the type soup, purée or sauce in which the ingredients of the deep-frozen finished product comprise deep-frozen ingredients, and in which at least some of the deep-frozen ingredients are cold processed to a cold emulsion.

By the cold processing of the deep-frozen ingredients to a cold emulsion a deep-frozen finished product of the type soup, sauce or purée is obtained which can be simply prepared by the consumer to a consumable end product, without additional ingredients such as water having to be added. A soup, purée or sauce is thus obtained which is already in the final form with regard to liquidity, consistency, flavor and ingredients.

In a preferred embodiment of a deep-frozen finished product according to the invention, the cold emulsion comprises a binding agent which has binding properties in the cold and warm state.

In the cold state the binding agent acts as a stabilizer for the purpose of preventing separation of the soup, sauce or purée into a liquid and a solid phase. The binding agent also has the function of making the homogenization of the product proceed better during the preparation phase of the cold emulsion. In the warm state the binding agent takes care that the binding capabilities are retained when the deep-frozen finished product undergoes a cooking heat treatment.

In a preferred embodiment of a deep-frozen finished product according to the invention, the binding agent is a natural binding agent.

In an advantageous embodiment of a deep-frozen finished product according to the invention, the cold emulsion contains chilled water and/or other refrigerated-fresh ingredients with a maximum temperature of 5° C.

In a preferred embodiment of a deep-frozen finished product according to the invention, the other part of the deep-frozen ingredients is added to the cold emulsion.

In an advantageous embodiment of a deep-frozen finished product according to the invention, the deep-frozen ingredients consist mainly of IQF ingredients.

In a preferred deep-frozen finished product according to the invention, the deep-frozen and/or IQF ingredients include frozen-fresh vegetables.

In an advantageous embodiment of a deep-frozen finished product according to the invention, the deep-frozen and/or IQF ingredients comprise frozen-fresh vegetables.

Frozen-fresh vegetables means vegetables which are blanched after (as short as possible a period after) harvesting and are then immediately frozen.

In an advantageous embodiment of a deep-frozen finished product according to the invention, the deep-frozen finished product includes a steam-cook package.

A steam-cook package has the major advantage that an increased pressure can be created in the package, so that the boiling point is lowered and the cooking time is reduced, so that cooking is done by the known principle of the pressure cooker. In this way a healthy soup, sauce or purée which can be quickly prepared by the consumer is obtained which can stand comparison with a traditional home-made soup, with maximum retention of the odor, color, texture, flavor and vitamin content of the ingredients. Another advantage of a steam-cook package is that the contents of the package can be cooked and eaten in the same package.

In a preferred deep-frozen finished product according to the invention, the cold emulsion has a temperature between 0° C. and 5° C.

As a result one can be sure that the microbiology of the deep-frozen finished product remains guaranteed.

In a preferred deep-frozen finished product according to the invention, the cold emulsion is pumpable.

In this way the process of manufacturing the deep-frozen finished product can be automated in a simple way and the cold emulsion, with or without additional IQF ingredients, can be more easily put in the right amount into the package.

On the other hand, the object of the invention is to provide a method for the manufacture of a deep-frozen finished product of the type soup, purée or sauce, wherein the ingredients of the deep-frozen finished product comprise deep-frozen ingredients, and wherein a deep-frozen finished product is obtained wherein the consumer can make the deep-frozen finished product ready for consumption (consumable) in a simple manner, without adding additional ingredients, and furthermore the deep-frozen finished product only once has to undergo a cooking heat treatment in order to make the deep-frozen finished product ready for consumption.

This object of the invention is achieved by providing a method for the manufacture of a deep-frozen finished product of the type soup, purée or sauce in which the ingredients of the deep-frozen finished product include deep-frozen ingredients, and in which at least some of the deep-frozen ingredients are cold processed to a cold emulsion.

In a preferred method according to the invention, during the cold processing of the deep-frozen ingredients a binding agent is added which has binding properties in the cold and warm state.

In an advantageous embodiment of a method according to the invention, during the cold processing of the deep-frozen ingredients to a cold emulsion chilled water and/or other refrigerated-fresh ingredients with a maximum temperature of 5° C. are added.

In a preferred embodiment of a method according to the invention, the deep-frozen ingredients consist mainly of IQF ingredients.

In a preferred method according to the invention, the cold emulsion and any IQF ingredients added thereto are packaged in a steam-cook package

In a preferred method according to the invention, the cold emulsion is pumpable.

A method according to the invention preferably includes the following steps:
cold processing of the said part of the deep-frozen ingredients to a cold emulsion, wherein any binding agent, which has binding properties both in the cold and in the warm state, chilled water and/or other refrigerated-fresh ingredients with a maximum temperature of 5° C. are added during the processing;
adding any other part of the deep-frozen ingredients to this cold emulsion;
putting the whole into a steam-cook package;
freezing the filled steam-cook package to a temperature of −18° C.

In a preferred method according to the invention a deep-frozen finished product is manufactured as described above.

In the following detailed description and the examples, deep-frozen finished products, the above-mentioned characteristics and advantages of according to the invention will be further clarified. The purpose of these examples and the associated description is only intended to clarify the general principle of the present invention, therefore nothing in this description may be interpreted as a restriction of the field of application of the invention and of the patent rights demanded for in the claims.

In a deep-frozen finished product of the type soup, purée or sauce according to the invention, the ingredients of the deep-frozen finished product include deep-frozen ingredients.

In addition the ingredients can also include refrigerated-fresh ingredients with a maximum temperature of 5° C. A part of the deep-frozen ingredients, with or without the refrigerated-fresh ingredients, are cold processed to a cold emulsion, for example by mixing them. In addition a binding agent, preferably a natural binding agent, which has binding properties in the cold and warm state can also be added. Such a binding agent has the characteristic that the binding pattern is developed from a temperature of 20° C. upwards, and that complete binding occurs from about 65° C. upwards, and it retains its binding capabilities if it is further heated to 100° C. An example of such a binding agent includes amongst others modified starch (E1414), stabilizers (guar (E412) and xanthan (E415). During the processing of the deep-frozen ingredients chilled water can furthermore be added, in order to keep the temperature of the cold emulsion as low as possible. In addition to the chilled water, refrigerated-fresh ingredients such as cream, milk, etc., can be processed in the cold emulsion. Such products are above all added for the preparation of sauces. However, these refrigerated-fresh ingredients can also be added in the preparation of certain soups or purées.

The cold emulsion which is obtained is a liquid, sometimes pasty mass (purée). The temperature of the emulsion is between 0° C. and 5° C., preferably as close as possible to 0° C., in order to obtain a deep-frozen finished product with a guaranteed microbiology.

The deep-frozen ingredients can consist both of block-frozen and of IQF ingredients. This last is to be preferred. The abbreviation IQF stands for “Individual Quick Frozen” and indicates a freezing process where the ingredients are frozen individually in a very rapid manner (a few seconds to a maximum of a few minutes) at a temperature down to −40° C. This process is to be compared with a freezing process which takes place at a temperature down to −18° C., wherein ingredients are frozen portioned in a freezer, which takes a few hours and results in a coherent block. The major advantage of the use of IQF foods is that there is maximum retention of vitamins, texture, odor and flavor as a result of minimum damage to the cell structure during the rapid conversion of water to ice crystals in the freezing process.

Any other part of the deep-frozen ingredients (which may or may not have to be added, depending on the formulation) is added to the cold emulsion. Here too IQF ingredients are preferably used. These ingredients which are added may be either in the form of vegetables or in the form of meat, chicken, etc. In the same way a complete meal soup can for example be obtained. Deep-frozen ingredients can also be added when sauces or purées are being made, for example in the preparation of a mushroom sauce or the preparation of a broccoli purée with small pieces of bacon.

The cold emulsion, with or without added deep-frozen ingredients, is preferably pumpable. This has the additional advantage that the whole can also be easily measured out in the right amount.

The deep-frozen and/or IQF ingredients preferably include frozen-fresh vegetables. As already stated above, frozen-fresh vegetables means vegetables which are preferably first blanched very soon after harvesting, and then deep-frozen. Blanching means subjecting a food to a brief heat treatment at a temperature which is usually below 100° C., preferably between 75° C. and 90° C., for a period between 30 seconds and 2,5 minutes, depending on the vegetable to be blanched, after which the food is rinsed with cold water. The blanching process is carried out in order to inactivate the enzymes which reduce the quality and the shelf life of the food, and in order to achieve microbiological sterilization.

The cold emulsion prepared, with or without the added IQF ingredients, is then packaged in a steam-cook package, after which this is frozen in a rapid manner (statically) from a temperature between 0° C. and 5° C. to a temperature of −18° C., so that a deep-frozen finished product is obtained. The steam-cook package is suitable for heating up in a microwave oven. A steam-cook package consists of a bowl or dish which is covered and sealed with a film, in which a certain overpressure, generated by the steam, can escape along one or more channels in the film. Through the creation of an increased pressure in the package the boiling point is lowered and the cooking time is reduced, and cooking is done by the known principle of the pressure cooker. In this way a healthy soup, sauce or purée which can be quickly prepared by the consumer is obtained which can stand comparison with a traditional home-made soup, with maximum retention of the odor, color, texture, flavor and vitamin content of the ingredients, and as a result of which, among other things, flavor enhancers are superfluous, as is the case for example in US 2003/0185944 and GB 2 025 197.

### EXAMPLE 1

### Preparation of Grain Mustard Sauce

TABLE 1
Composition of grain mustard sauce

| Ingredients | % |
|---|---|
| cream 35% (3° C.) | 41.93 |
| semi-skimmed milk (3° C.) | 30.29 |
| chilled water (0–3° C.) | 15.15 |
| grain mustard paste | 12.63 |
| margarine (palm fat & rapeseed/sunflower oil) | |
| shallot | |
| maize starch (EI422) | |
| vinegar | |
| mustard seed | |
| rice starch | |
| salt | |
| lemon juice | |
| Total | 100 |

The ingredients of the grain mustard paste and the chilled water are cold processed to a cold, smooth emulsion. The cream and the semi-skimmed milk are then added and mixed. The whole is packaged in a steam package and is (statically) frozen to a temperature of about −18° C., so that a deep-frozen finished product is obtained. The deep-frozen finished product should be steam-cooked by the consumer for about 9 minutes at 750 Watt in a microwave oven.

### EXAMPLE 2

### Preparation of Tomato Soup with Poultry Meat Balls

TABLE 2
Composition of tomato soup with poultry meat balls

| Ingredients | | % |
|---|---|---|
| soup base | | 82.53 |
| chilled water (0–3° C.) | 42.60 | |
| tomato pulp | 14.82 | |
| chicken stock (IQF) | 5.00 | |
| onion cube (grilled) (IQF) | 3.95 | |
| carrot cube (IQF) | 3.67 | |
| white celery (IQF) | 2.35 | |
| potato chunks (blanched) (IQF) | 2.22 | |
| chicken base (3° C.) | 0.75 | |
| white pepper | 0.01 | |
| culinary cream 20% (3° C.) | 1.72 | |
| herb mixture + binding agent | 5.34 | |
| parsley | 0.1 | |
| tomato cube (IQF) | | 7.47 |
| meat balls (IQF) | | 10.00 |
| Total | | 100 |

The ingredients of the soup base, except the cream and the parsley, are cold processed to a cold emulsion. Thereafter, the cream and the parsley are mixed in, and next the tomato cube and the meat balls. Thereafter, the whole is packaged in a steam package and (statically) frozen to a temperature of about −18° C., through which a deep-frozen finished product is obtained. The deep-frozen finished product must be steam-cooked by the consumer for about 9 minutes at 750 Watt in a microwave oven.

### EXAMPLE 3

### Preparation of Minestrone Soup with Bacon

TABLE 3
Composition of minestrone with bacon

| Ingredients | | % |
|---|---|---|
| soup base | | 60.59 |
| chilled water (0–3° C.) | 89.54 | |
| tomato purée | 4.93 | |
| herb mixture | 5.53 | |
| bacon strips (IQF) | | 8.00 |
| carrot cube (IQF) | | 4.49 |
| green beans (IQ F) | | 3.49 |
| paprika cube (IQF) | | 3.49 |
| onion cube (IQF) | | 3.49 |
| chopped blanched celery (IQF) | | 3.49 |
| tomato cube (IQF) | | 2.99 |
| borlotti beans (IQF) | | 2.99 |
| fennel cube (IQF) | | 2.49 |
| turnip cube (IQF) | | 2.49 |
| spinach flakes (IQF) | | 2.00 |
| Total | | 100 |

The ingredients of the soup base are cold processed to a cold emulsion. Thereafter, the other IQF ingredients are added. The whole is packaged in a steam package and (statically) frozen to a temperature of about −18° C., through which a deep-frozen finished product is obtained. The deep-frozen finished product must be steam-cooked by the consumer for about 9 minutes at 750 Watt in a micro wave oven.

### EXAMPLE 4

### Preparation of Broccoli Vegetable Purée

TABLE 4
Composition of broccoli vegetable purée

| Ingredients | % |
|---|---|
| broccoli rosettes (IQF) | 50.66 |
| potato chunks (IQF) | 13.12 |
| semi-skimmed milk (3° C.) | 25.4 |
| vegetable bouillon (IQF tablets) | 5.00 |
| vegetable oil with butter aroma | 5.00 |
| herb mixture | 0.82 |
| Total | 100 |

The ingredients of the vegetable purée are cold processed to a cold emulsion which is put into a steam package and (statically) frozen to a temperature of about −18° C., through which a deep-frozen finished product is obtained. The deep-frozen finished product must be steam-cooked by the consumer for about 8-9 minutes at 750 Watt in a microwave oven.

1. Deep-frozen finished product of the type soup, purée or sauce, wherein the ingredients of the deep-frozen finished product comprise deep-frozen ingredients, characterized in that at least some of the deep-frozen ingredients are cold processed to a cold emulsion.

2. Deep-frozen finished product according to claim 1, characterized in that the cold emulsion comprises a binding agent which has binding properties in the cold and warm state.

3. Deep-frozen finished product according to claim 2, characterized in that the binding agent is a natural binding agent.

4. Deep-frozen finished product according to claim 1, characterized in that the cold emulsion comprises chilled water and/or other refrigerated-fresh ingredients with a maximum temperature of 5° C.

5. Deep-frozen finished product according to claim 1, characterized in that the other part of the deep-frozen ingredients is added to the cold emulsion.

6. Deep-frozen finished product according to claim 1, characterized in that the deep-frozen ingredients substantially consist of IQF ingredients.

7. Deep-frozen finished product according to claim 1, characterized in that the deep-frozen and/or IQF ingredients include frozen-fresh vegetables.

8. Deep-frozen finished product according to claim 1, characterized in that the deep-frozen finished product comprises a steam-cook package.

9. Deep-frozen finished product according to claim 1, characterized in that the cold emulsion has a temperature between 0° C. and 5° C.

10. Deep-frozen finished product according to claim 1, characterized in that the cold emulsion is pumpable.

11. Method for the manufacture of a deep-frozen finished product of the type soup, purée or sauce, wherein the ingredients of the deep-frozen finished product comprise deep-frozen ingredients, characterized in that at least some of the deep-frozen ingredients are cold processed to a cold emulsion.

12. Method according to claim 11, characterized in that during the cold processing of the deep-frozen ingredients a binding agent is added which has binding properties in the cold and warm state.

13. Method according to claim 11, characterized in that during the cold processing of the deep-frozen ingredients to a cold emulsion chilled water and/or other refrigerated-fresh ingredients with a maximum temperature of 5° C. are added.

14. Method according to claim 11 inclusive, characterized in that the deep-frozen ingredients consist substantially of IQF ingredients.

15. Method according to claim 11, characterized in that the cold emulsion and any IQF ingredients added thereto are packaged in a steam-cook package.

16. Method according to claim 11, characterized in that the cold emulsion is pumpable.

17. Method according to claim 11, characterized in that the method includes the following steps:
the cold processing of the said part of the deep-frozen ingredients to a cold emulsion, wherein any binding agent, which has binding properties both in the cold and in the warm state, chilled water and/or other refrigerated-fresh;
ingredients with a maximum temperature of 5° C. are added during the processing;
adding any other part of the deep-frozen ingredients to this cold emulsion;
putting the whole into a steam-cook package;
freezing the filled steam-cook package to a temperature of −18° C.

18. Method according to claim 11, characterized in that a deep-frozen finished product is manufactured.
